(19) United States
(12) Patent Application Publication
(10) Pub. No.: US 2026/0266104 A1
(43) Pub. Date: Sep. 10, 2026

(54) DOOR LATCH DEVICE

(71) Applicant: U-Shin Ltd., Nagano (JP)

(72) Inventors: Kouhei YAMASAKI, Hiroshima (JP); Hideto TAKENAKA, Hiroshima (JP)

(21) Appl. No.: 19/549,140

(22) Filed: Feb. 25, 2026

(30) Foreign Application Priority Data
Mar. 7, 2025 (JP) 2025-036796

(51) Int. Cl. E05B 81/16; E05B 77/30; E05B 81/06; E05B 81/30; E05B 81/36; E05B 83/36

(52) U.S. Cl. CPC E05B 81/16; E05B 77/30; E05B 81/06; E05B 81/30; E05B 81/36; E05B 83/36

(57) ABSTRACT

A door latch device includes a latch mechanism that releasably holds a striker, a lock mechanism that is switchable between an unlocked state and a locked state, an inner lever including a cable coupling part and an opening operation part, and a rotor pivotally supported to allow pivot with a motor. The lever shaft of the inner lever is disposed below the rotor shaft of the rotor, and the cable coupling part of the inner lever is disposed between the lever shaft 13e and the rotor shaft. The rotor is provided with an operation receiving part that receives an operation from at least either a lock knob or the inner lever to be positioned between the lever shaft and the rotor shaft.

### CROSS REFERENCE TO RELATED APPLICATION

This application claims benefit of priority to Japanese Patent Application No 2025-036796, filed on Mar. 7, 2025, the entire content of which is incorporated herein by reference.

### BACKGROUND

### Technical Field

The present invention relates to a door latch device.

### Background Art

A door latch device used in a vehicle includes a latch mechanism, a lock mechanism, and an opening mechanism. The latch mechanism is switchable between a latched state in which a door is maintained in a closed state with respect to a vehicle body and an unlatched state in which the door is openable with respect to the vehicle body. The lock mechanism is switchable between an unlocked state in which an operating force of a door handle provided on the door can be transmitted to the latch mechanism and a locked state in which the operating force cannot be transmitted to the latch mechanism. When the lock mechanism is in the unlocked state, the opening mechanism transmits the operating force of the door handle to the latch mechanism via the lock mechanism to switch the latch mechanism to the unlatched state.

In the door latch device disclosed in JP 2011-26867 A, an inner lever constituting an opening mechanism is disposed in a lower portion of a housing, and an inner cable connected to an inner door handle is coupled to the inner lever. The rotor constituting the lock mechanism is disposed above the inner lever in the housing, and the one end of the knob cable having the other end connected to the lock knob of the door is coupled to the rotor. The cable coupling part of the inner lever protrudes upward with respect to the rotary shaft of the rotor positioned on the upper side. The cable coupling part of the rotor protrudes below the rotary shaft of the inner lever positioned below. The inner lever and the rotor are pivotally disposed on the same disposition surface of the housing so as not to interfere with each other.

### SUMMARY

In the door latch device of JP 2011-26867 A, because the cable coupling part of the inner lever and the cable coupling part of the rotor are disposed to be vertically separated from each other, it is necessary to individually secure these pivot spaces in the housing. As a result, the door latch device is increased in size. Thus, the door latch device of JP 2011-26867 A has room for improvement in downsizing of the entire device.

The problem related to the increase in size is not limited to the door latch device described in JP 2011-26867 A, but it may also occur in a door latch device having an override function capable of switching a lock mechanism to an unlocked state through operation of an inner door handle. In the door latch device having an override function, an operation projection protruding from the inner lever is further provided, and an operation receiving part that receives an operation of the operation projection protrudes from the rotor. Thus, it is necessary to secure a pivot space of the operation projection of the inner lever and the operation receiving part of the rotor in the housing, and the entire door latch device can be enlarged. Thus, there is room for improvement in miniaturization of the entire door latch device.

An object of the present invention is to downsize a door latch device including an inner lever coupled to an inner door handle and a rotor operated by a lock knob or the inner lever.

The present invention is provided with a door latch device including: a latch mechanism that is mounted in a door and releasably holds a striker provided in a vehicle body; a lock mechanism that is switchable between an unlocked state in which an operating force of an inner door handle provided in the door can be transmitted to the latch mechanism and a locked state in which the operating force cannot be transmitted; an inner lever including a first cable coupling part to which one end of a first cable having the other end connected to the inner door handle is coupled, and an opening operation part that transmits the operating force of the inner door handle to the latch mechanism via the lock mechanism in the unlocked state, the inner lever being pivotally supported by a lever shaft; and a rotor including a switching operation part that switches the lock mechanism between the locked state and the unlocked state, the rotor being pivotally supported by a rotor shaft extending along the lever shaft to allow pivot with a motor, wherein the lever shaft of the inner lever is disposed below the rotor shaft of the rotor, the first cable coupling part of the inner lever is disposed between the lever shaft and the rotor shaft, and the rotor is provided with an operation receiving part that receives an operation from at least either a lock knob provided on the door or the inner lever to be positioned between the lever shaft and the rotor shaft.

The lever shaft of the inner lever is disposed below the rotor shaft of the rotor, and the first cable coupling part of the inner lever is disposed between the lever shaft and the rotor shaft. The rotor is provided with an operation receiving part so as to be positioned between the lever shaft and the rotor shaft. That is, the first cable coupling part of the inner lever and the operation receiving part of the rotor are disposed between the lever shaft and the rotor shaft. Thus, it is not necessary to individually secure the pivot spaces of the first cable coupling part of the inner lever and the operation receiving part of the rotor. Therefore, the door latch device can be downsized as compared with the case where the pivot spaces of the first cable coupling part of the inner lever and the operation receiving part of the rotor are individually secured.

The operation receiving part of the rotor receives an operation from at least either a lock knob or an inner lever provided on the door. Specifically, by coupling the cable coupled to the lock knob to the operation receiving part of the rotor, it is possible to configure a door latch device of a lock knob specification in which the lock mechanism is switched between a locked state and an unlocked state through operation of the lock knob. On the other hand, the door latch device of the override specification in which the operation receiving part of the rotor receives the operation from the inner lever to switch the lock mechanism to the unlocked state through the operation of the inner door handle can be configured. In this manner, the door latch device of the lock knob specification and the door latch device of the override specification can be realized by a common component layout. Thus, it is possible to easily cope with the situation to choose the presence or absence of the override function determined by the request of the automobile manufacturer without changing the basic configuration.

In the present invention, it is possible to downsize a door latch device including an inner lever coupled to an inner door handle and a rotor operated by a lock knob or the inner lever.

### BRIEF DESCRIPTION OF DRAWINGS

FIG. 1 is a block diagram of a door latch device according to an embodiment of the present invention;

FIG. 2 is a front view of the door latch device;

FIG. 3 is an exploded perspective view of the door latch device;

FIG. 4 is a front perspective view of the door latch device from which a housing is removed;

FIG. 5 is a rear perspective view of the door latch device from which the housing is removed;

FIG. 6 is an exploded perspective view of FIG. 4;

FIG. 7 is an exploded perspective view of FIG. 5;

FIG. 8 is an exploded perspective view of the lock mechanism, a switching mechanism, and an opening mechanism of FIG. 4;

FIG. 9 is an exploded perspective view of the lock mechanism, the switching mechanism, and the opening mechanism of FIG. 5;

FIG. 10 is a rear view illustrating an orientation of the lock mechanism and an outer lever in an unlocked state and a door handle unoperated state;

FIG. 11 is a rear view illustrating an orientation of the lock mechanism and the outer lever in a locked state and the door handle unoperated state;

FIG. 12 is a rear view illustrating an orientation of the lock mechanism and the outer lever in the locked state and a door handle operated state;

FIG. 13 is a rear view illustrating an orientation of the lock mechanism, a rotor, and an inner lever in the unlocked state and the door handle unoperated state;

FIG. 14 is a rear view illustrating an orientation of the lock mechanism, the rotor, and the inner lever in the unlocked state and the door handle operated state; and

FIG. 15 is a rear view illustrating an orientation of the lock mechanism, the rotor, and the inner lever in the locked state and the door handle unoperated state.

### DETAILED DESCRIPTION

Hereinafter, an embodiment of the present invention will be described with reference to the drawings.

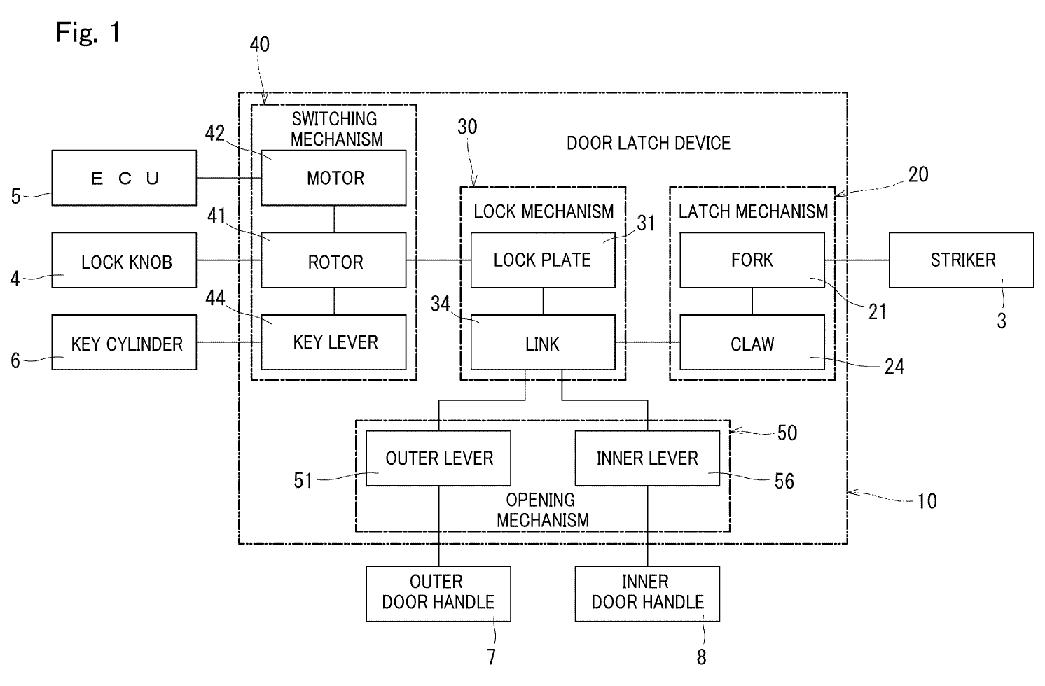

See FIGS. 1 to 3. A door latch device 10 according to an embodiment of the present invention is attached to a door 1 of a vehicle, and is configured to maintain the door 1 in a closed state to be openable with respect to a vehicle body (not illustrated).

The X direction in the accompanying drawings is a vehicle length direction, the direction indicated by the arrow is a forward direction, and the direction opposite to the arrow is a rearward direction. The Y direction is a vehicle width direction, the direction indicated by the arrow is a vehicle outward direction, and the direction opposite to the arrow is a vehicle inward direction. The Z direction is a vehicle height direction, the direction indicated by the arrow is an upward direction, and the direction opposite to the arrow is a downward direction.

First, the door 1 of the vehicle includes an internal space defined by an inner panel 2 located on the inner side in the vehicle width direction, an outer panel (not illustrated) located on the outer side of the inner panel 2 in the vehicle width direction, and an end panel (not illustrated) located on the rear side in the vehicle length direction. The internal space is located on the front side in the vehicle length direction with respect to the end panel. The internal space side with respect to the end panel is the door inner side in the present invention, and the rear side in the vehicle length direction with respect to the end panel is the door outer side in the present invention.

The door latch device 10 of the present embodiment is for a right-side door pivotable about a hinge shaft extending in the vehicle height direction. The door latch device 10 may be for a left-side door or for a hatchback. The door 1 may be a gullwing door pivotable about a rotary shaft extending in the vehicle length direction, or may be a sliding door movable along the vehicle body.

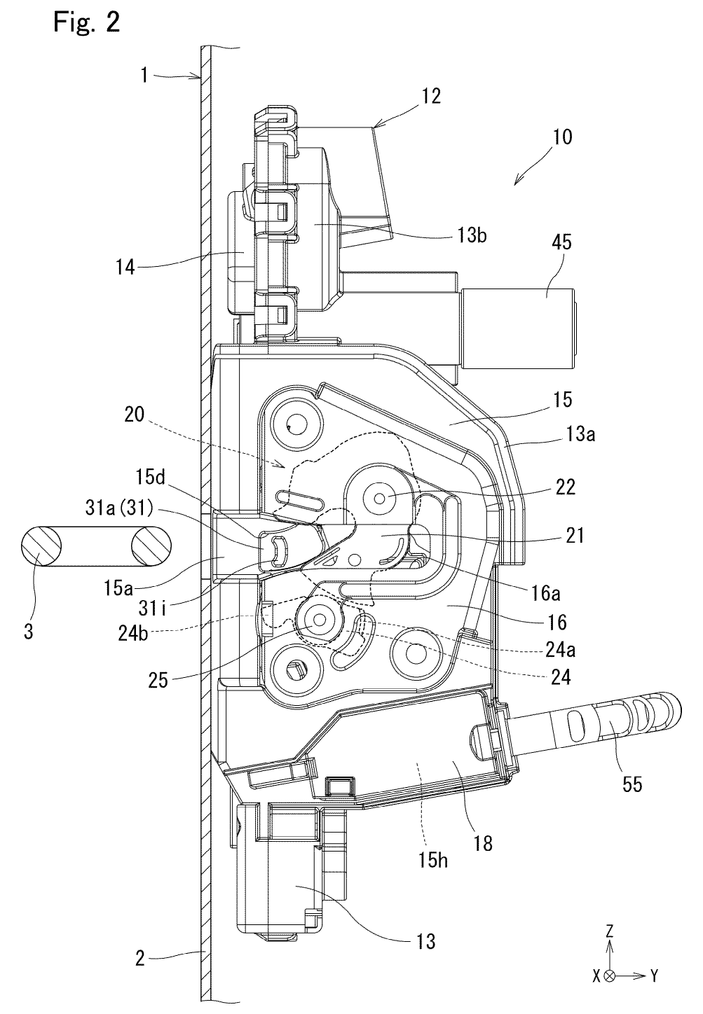

See FIGS. 1 and 2. The door latch device 10 is attached to the door 1 along the outer side of the inner panel 2 in the vehicle width direction and the front side of the end panel in the vehicle length direction. The door latch device 10 includes a latch mechanism 20, a lock mechanism 30, a switching mechanism 40, and an opening mechanism 50 in a housing 12.

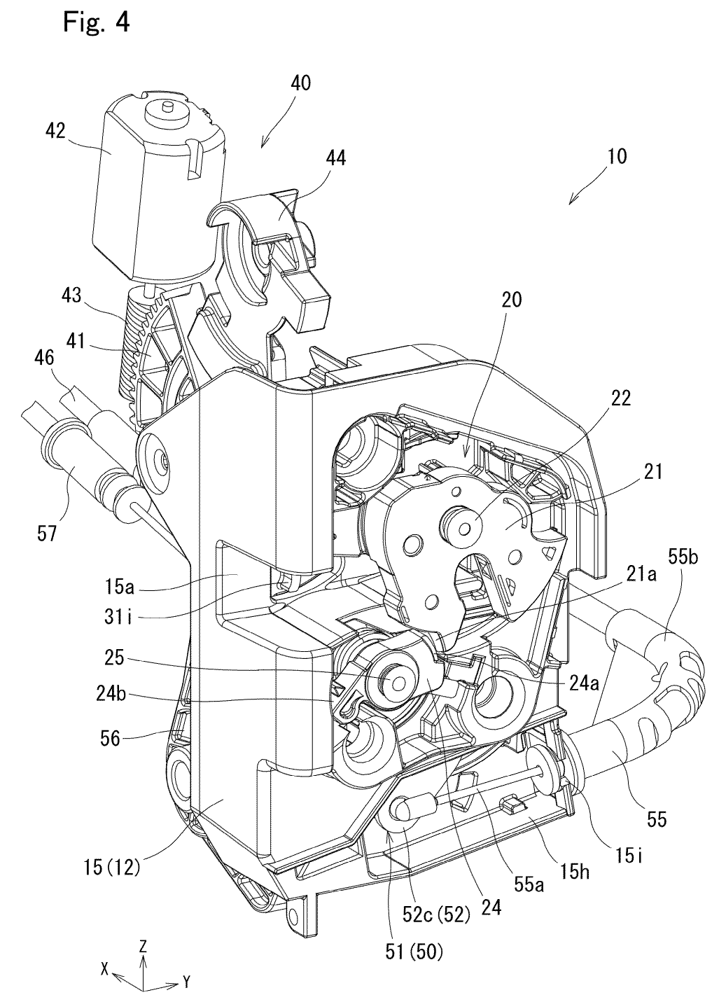

See FIGS. 1, 2, and 4. The latch mechanism 20 includes a fork 21 and a claw 24, and is switchable between the latched state illustrated in FIG. 4 and the unlatched state illustrated in FIG. 2. In the latched state illustrated in FIG. 4, the fork 21 pivots to a holding position, and the claw 24 pivots to a locking position. The door 1 is maintained in the closed state by the fork 21 holding a striker 3 (see FIG. 2) attached to the vehicle body and the claw 24 locking the fork 21 in the holding position. In the unlatched state illustrated in FIG. 2, the claw 24 pivots to a locking release position, and the fork 21 pivots to an opening position. The claw 24 releases the locking of the fork 21 and the fork 21 releases the striker 3, thereby allowing the door 1 to be opened.

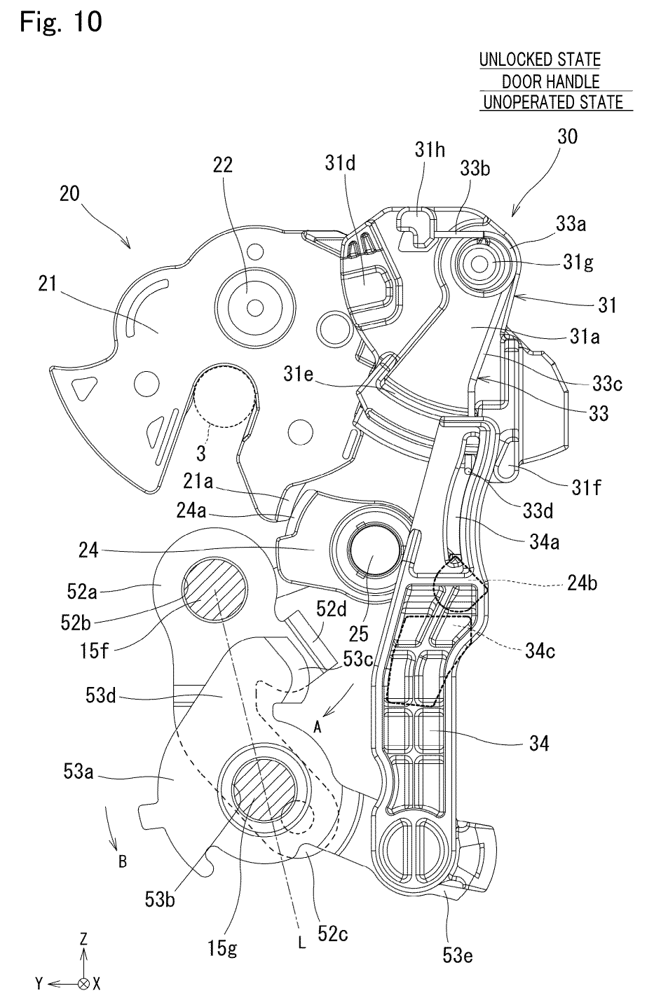

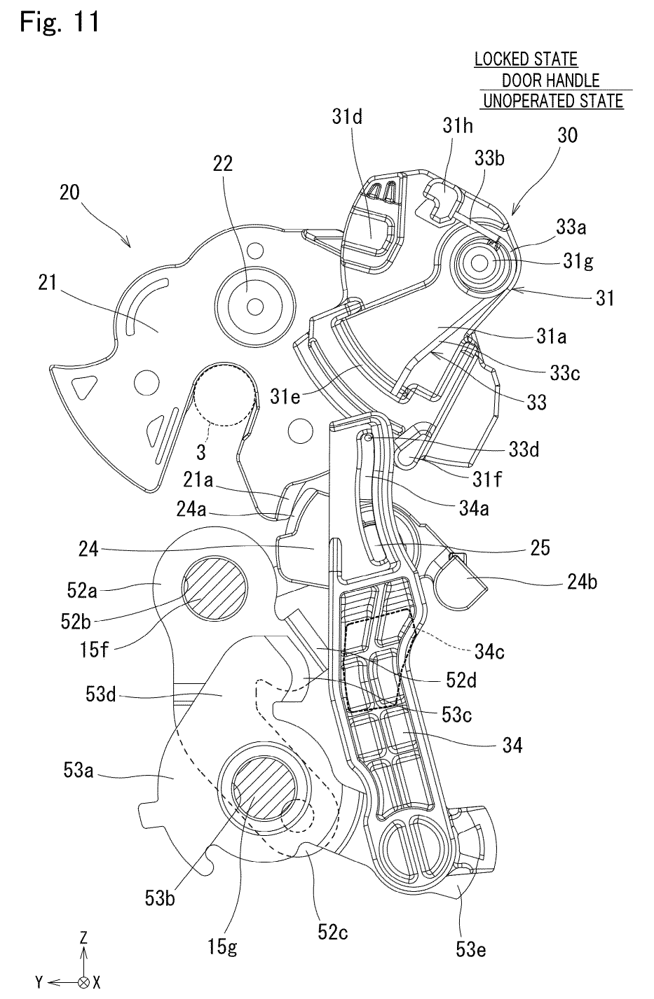

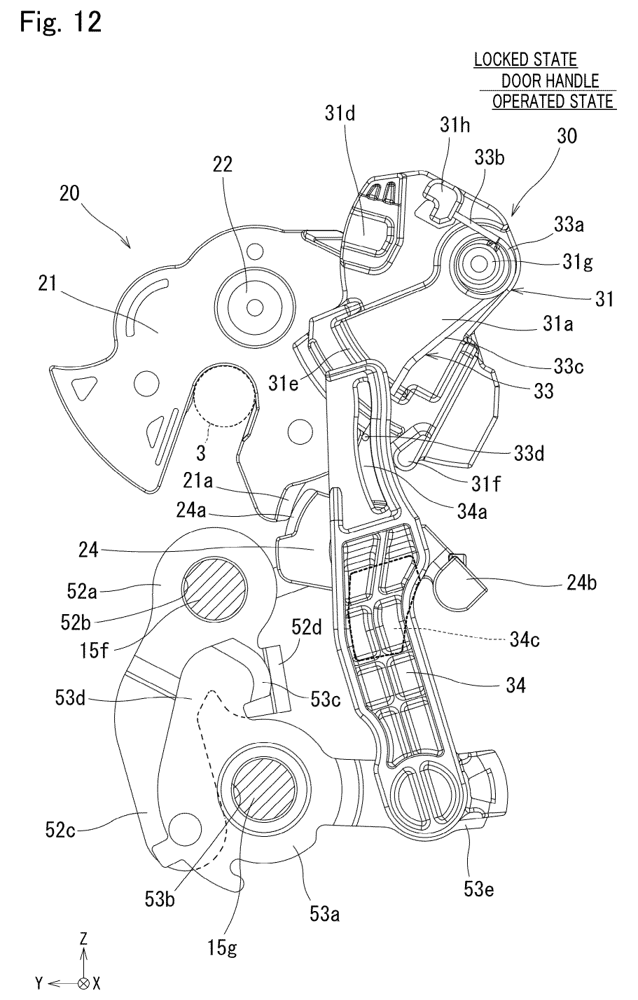

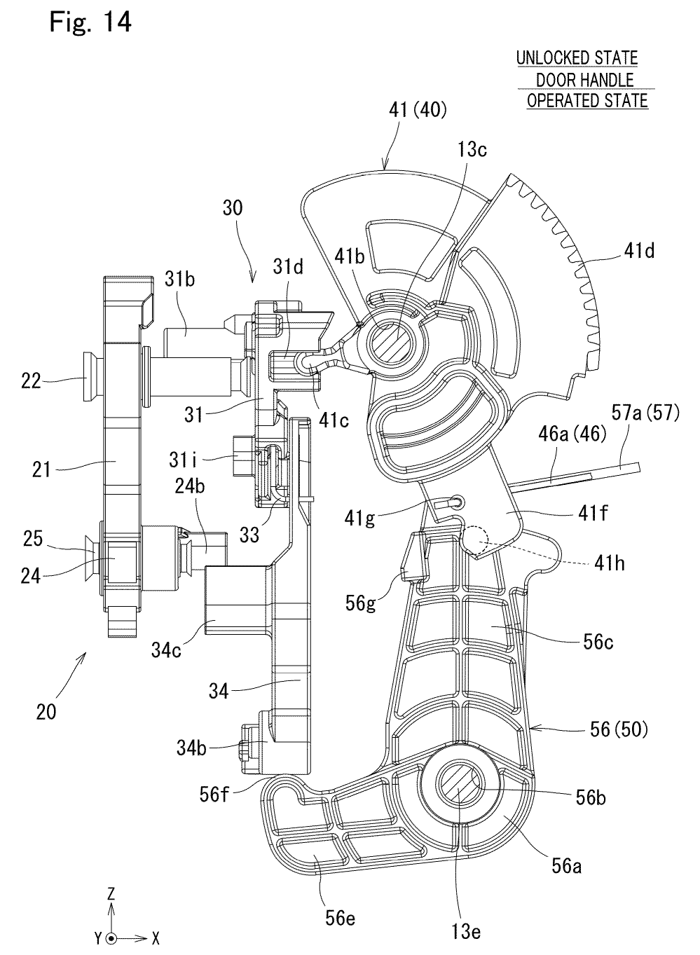

See FIGS. 1, 10, and 11. The lock mechanism 30 includes a lock plate 31 and a link 34, and is switchable between the unlocked state illustrated in FIG. 10 and the locked state illustrated in FIG. 11. In the unlocked state illustrated in FIG. 10, the link 34 is moved to an unlocked position by the lock plate 31. The link 34 in the unlocked position can move the claw 24 to the locking release position (see FIGS. 2 and 14) through upward movement with the opening mechanism 50. In the locked state illustrated in FIG. 11, the link 34 is moved to a locked position by the lock plate 31. The link 34 in the locked position cannot move the claw 24 to the locking release position even when moved upward by the opening mechanism 50 (see FIG. 12).

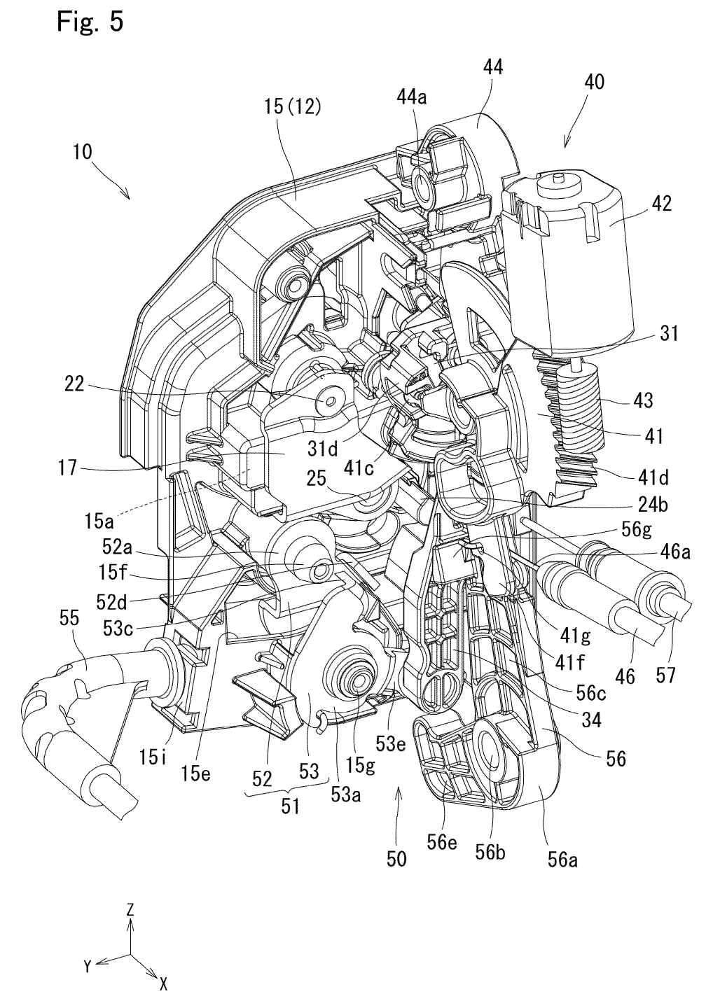

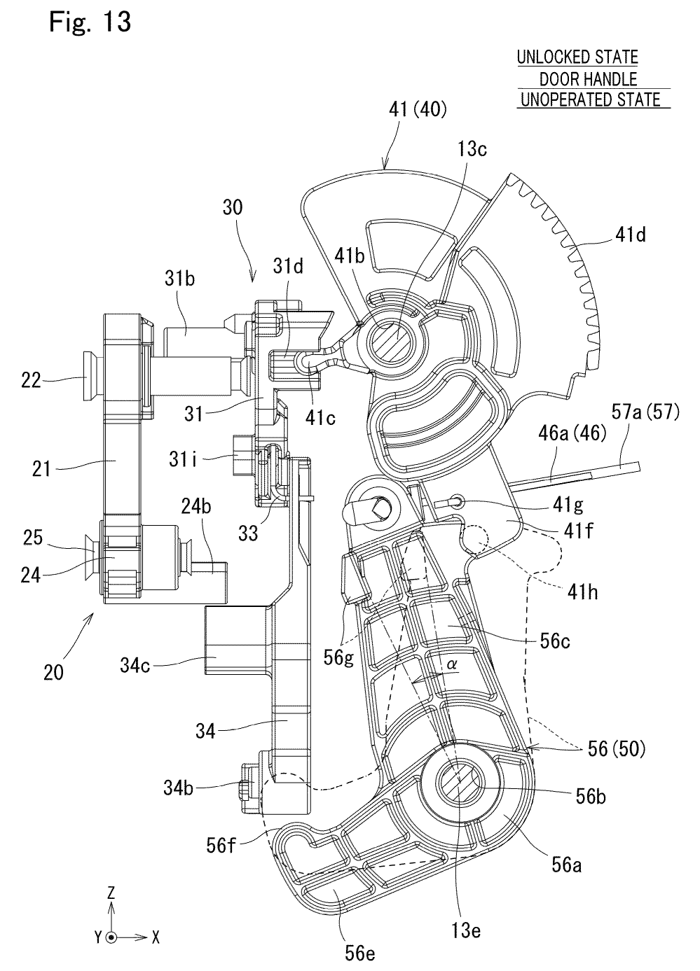

See FIGS. 1 and 5. The switching mechanism 40 is configured to switch the lock mechanism 30 between the unlocked state (see FIG. 10) and the locked state (see FIG. 11), including a rotor 41, a motor 42, and a key lever 44. The rotor 41 is coupled to the lock plate 31 and is connected to a lock knob 4 attached to the door 1 via a knob cable 46 (see FIG. 13). The motor 42 is mechanically connected to the rotor 41 and is communicably connected to an electronic control unit (ECU) 5 mounted on the vehicle. The key lever 44 is mechanically connected to the rotor 41 and is connected to a key cylinder 6 attached to the door 1 via a key rod (not illustrated).

The operating force of the lock knob 4, the driving force of the motor 42, and the operating force of the key cylinder 6 are transmitted to the link 34 via the rotor 41. This causes the link 34 to move to either the unlock position (see FIG. 10) or the lock position (see FIG. 11) together with the lock plate 31. As a result, the lock mechanism 30 is switched to either the unlocked state or the locked state.

See FIGS. 1 and 5. The opening mechanism 50 includes an open lever for switching the latch mechanism 20 to the unlatched state (see FIG. 2) via the link 34. The open lever includes an outer lever 51 and an inner lever 56. The outer lever 51 is coupled to the link 34 (see FIG. 10) and is connected to an outer door handle 7 attached to the door 1 via an outer door cable 55. The inner lever 56 is operably attached to the link 34 (see FIG. 13), and is connected to an inner door handle 8 attached to the door 1 via an inner door cable 57.

The operating force of the door handles 7 and 8 can be transmitted to the claw 24 via the link 34 when the lock mechanism 30 is in the unlocked state (see FIG. 10). This allows the latch mechanism 20 to switch to the unlatched state (see FIG. 2), and the door 1 can be opened. On the other hand, the operating force of the door handles 7 and 8 cannot be transmitted to the claw 24 via the link 34 (see FIG. 12) when the lock mechanism 30 is in the locked state (see FIG. 11). Thus, the latch mechanism 20 is maintained in the latched state (see FIG. 4), and the door 1 cannot be opened.

Next, configurations of the housing 12, the latch mechanism 20, the lock mechanism 30, the switching mechanism 40, and the opening mechanism 50 will be described more specifically.

### Basic configuration of housing

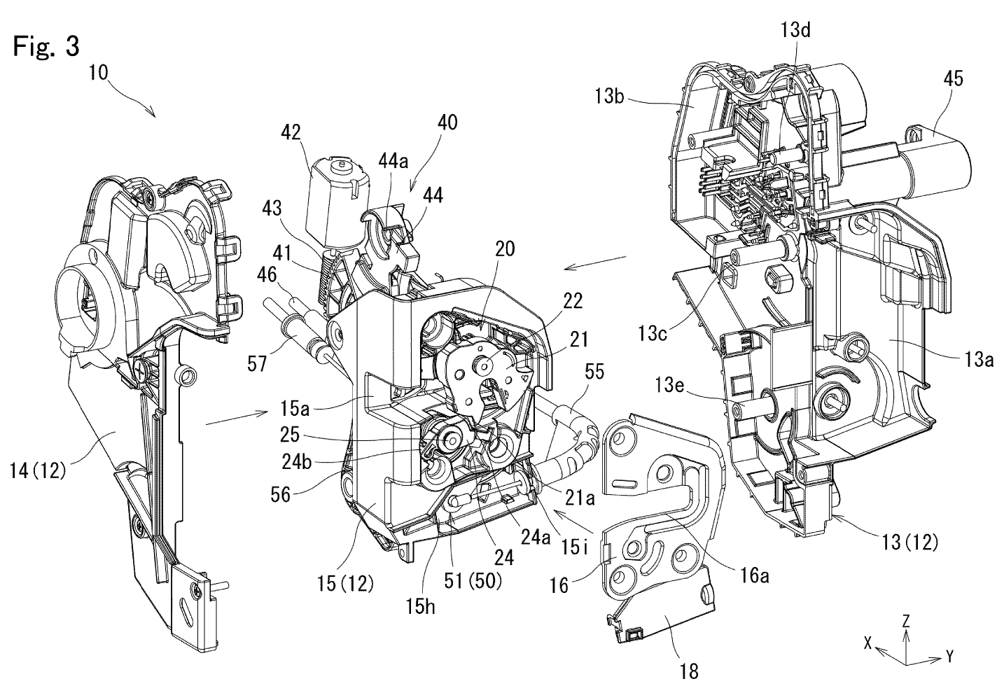

See FIGS. 2 and 3. The housing 12 includes a housing body 13, a housing cover 14, and a fence block 15. Among these, the housing body 13 has an L shape as viewed from the vehicle height direction and includes a first portion 13a extending in the vehicle width direction and the vehicle height direction along the end panel, and a second portion 13b extending in the vehicle length direction and the vehicle height direction along the inner panel 2. The housing cover 14 is attached to the housing body 13 so as to cover the second portion 13b. The fence block 15 is attached to the first portion 13a of the housing body 13. In the housing 12, an internal space defined by the first portion 13a and the fence block 15 and an internal space defined by the second portion 13b and the housing cover 14 communicate with each other.

See FIGS. 2 to 4. The fence block 15 has a plate shape and extends in the vehicle width direction and the vehicle height direction along the end panel. An insertion groove 15a into which the striker 3 (see FIG. 2) can be inserted is formed in the fence block 15. The insertion groove 15a is recessed from the rear side to the front side in the vehicle length direction and extends from the inner side to the outer side in the vehicle width direction. The outer side of the fence block 15 in the vehicle length direction is covered with a protective cover 16 made of metal. An insertion groove 16a corresponding to the insertion groove 15a is formed in the protective cover 16. A set plate 17 made of metal is attached to the front side of the fence block 15 in the vehicle length direction.

### Configuration of latch mechanism

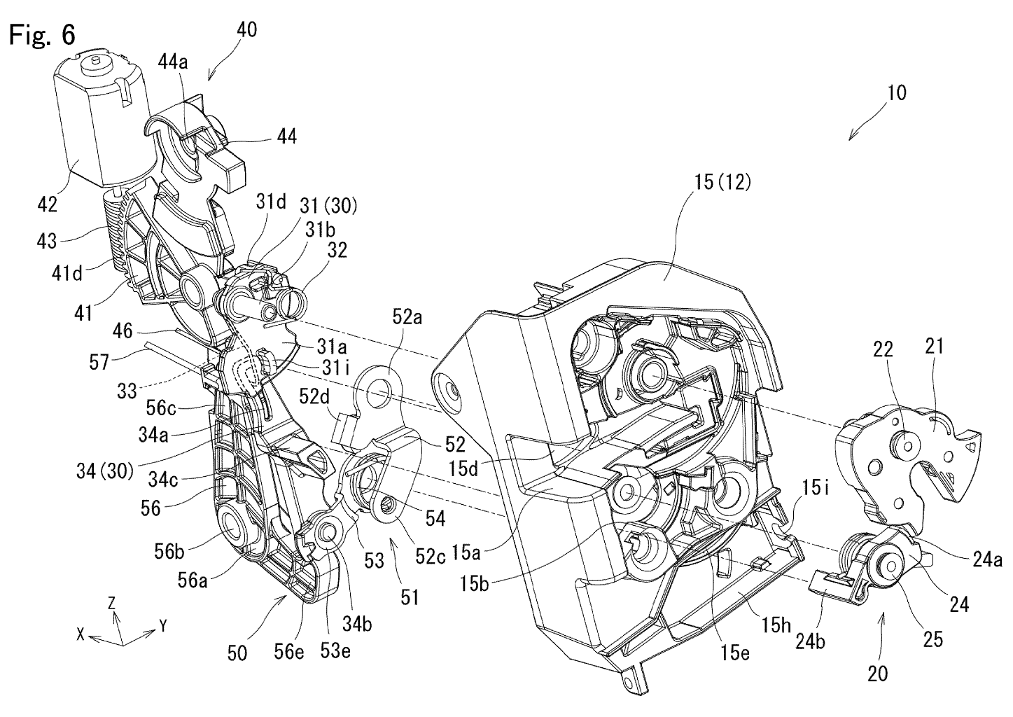

See FIGS. 4 and 6. The fork 21 and the claw 24 constituting the latch mechanism 20 are pivotally attached to the rear side (door outer side) of the fence block 15 in the vehicle length direction. The fork 21 is pivotally supported by a fork shaft 22 provided above the insertion groove 15a of the fence block 15. The claw 24 is pivotally supported by a claw shaft 25 provided below the insertion groove 15a of the fence block 15 so as to be adjacent to the fork 21. The fork shaft 22 and the claw shaft 25 are made of metal. They are riveted in a state of passing through the protective cover 16, the fence block 15, and the set plate 17. The claw shaft 25 is disposed on the inner side with respect to the fork shaft 22 in the vehicle width direction.

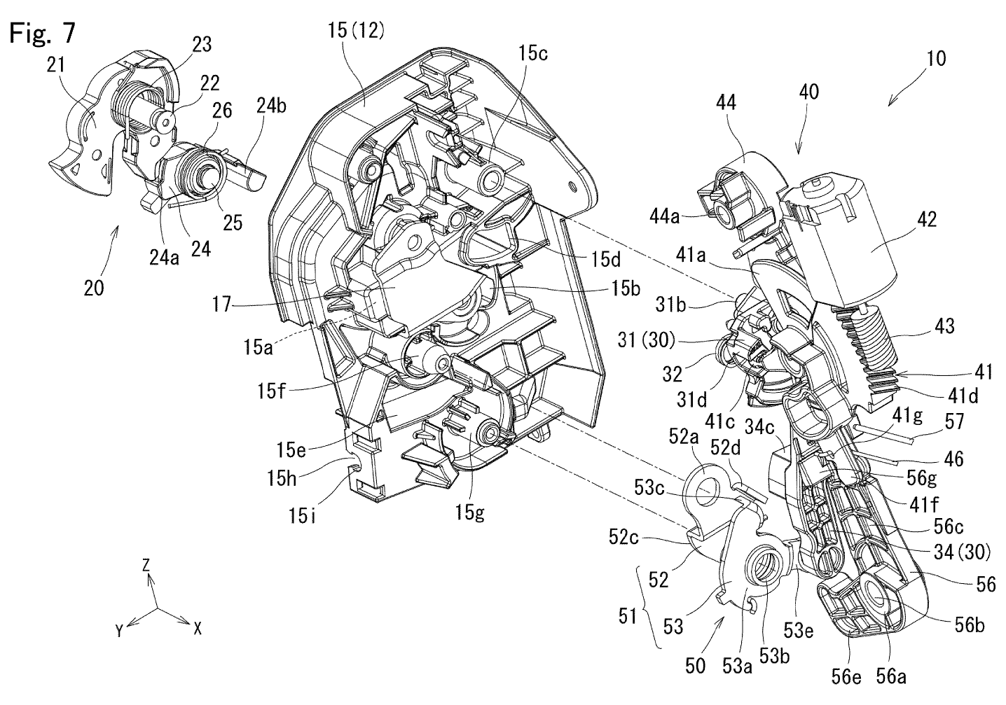

See FIG. 7. A spring 23 that biases the fork 21 to the opening position (see FIG. 2) is attached to the fork shaft 22. One end of the spring 23 is locked to the fork 21, and the other end of the spring 23 is locked to the fence block 15. A spring 26 that biases the claw 24 to the locking position (see FIG. 4) is attached to the claw shaft 25. One end of the spring 26 is locked to the claw 24, and the other end of the spring 26 is locked to the fence block 15.

See FIGS. 6, 7, and 13. The claw 24 is provided with a locking part 24athat locks the locked part 21a of the fork 21 and an opening operation receiving part 24b that receives an operation with the link 34. The opening operation receiving part 24b is provided at an end of the claw 24 on the inner side in the vehicle width direction which is opposite to the locking part 24a. The opening operation receiving part 24b has a rod shape, penetrates the fence block 15, and protrudes forward from the rear side in the vehicle length direction. The fence block 15 is provided with a penetration part 15b so as to correspond to the opening operation receiving part 24b. The penetration part 15b has a shape and a size that allow the movement of the opening operation receiving part 24b accompanying the pivot of the claw 24 between the locking position (see FIG. 4) and the locking release position (see FIG. 2).

### Configuration of lock mechanism

See FIGS. 5 and 7. The lock plate 31 and the link 34 constituting the lock mechanism 30 are pivotally attached to the front side (door inner side) of the fence block 15 in the vehicle length direction.

See FIGS. 7 to 9. The lock plate 31 includes a plate-like base plate 31a extending in the vehicle width direction and the vehicle height direction along the fence block 15. The base plate 31a is integrally provided with a pivot shaft 31b, a coupling receiving part 31d, an insertion groove 31e, and a positioning part 31f. The lock plate 31 includes a separate coupling spring 33 for coupling the link 34.

The pivot shaft 31b protrudes rearward in the vehicle length direction from the upper portion of the base plate 31a. The pivot shaft 31b is supported by a bearing part 15c provided in the fence block 15. The bearing part 15c has a cylindrical shape and protrudes forward in the vehicle length direction. The pivot shaft 31bincluding the bearing part 15cand the fork shaft 22 of the fork 21 extend in parallel in a direction orthogonal to the plate-like fence block 15. Through insertion of the pivot shaft 31b into the bearing part 15c, the lock plate 31 is pivotable between a first position where the link 34 is pivoted to the unlock position as illustrated in FIG. 10 and a second position where the link 34 is pivoted to the lock position as illustrated in FIG. 11. As long as the link 34 is pivotable to the unlock position through the operation of the lock plate 31, the pivot shaft 31b including the bearing part 15c does not have to extend in parallel with the fork shaft 22 of the fork 21 in a geometrically strict sense.

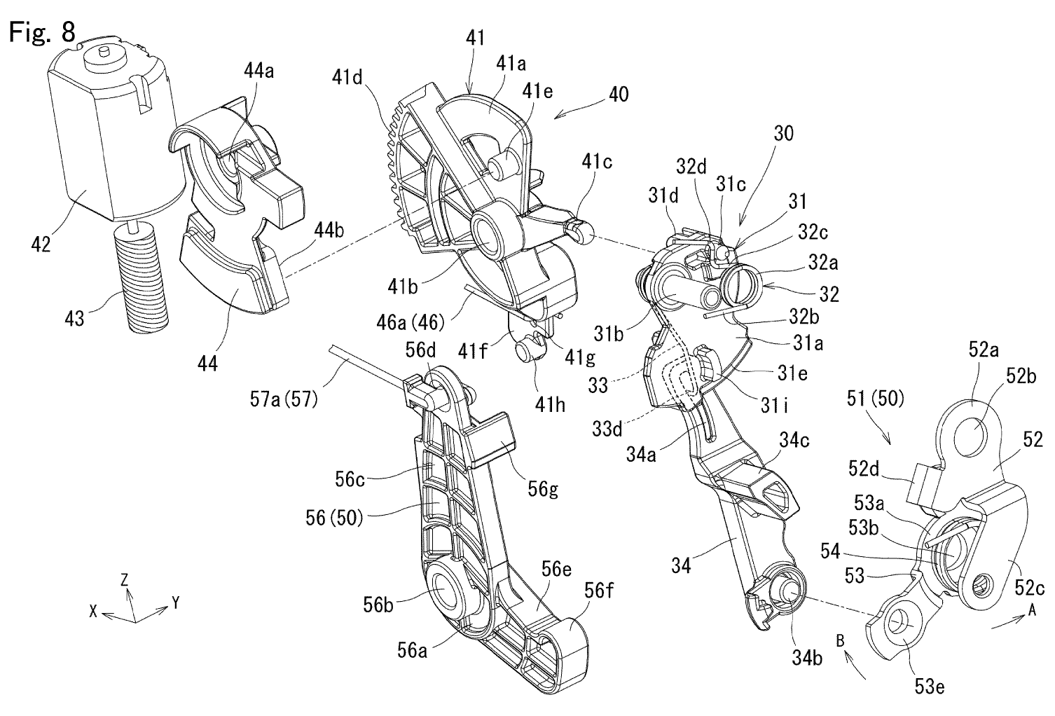

As illustrated most clearly in FIG. 8, the lock plate 31 is biased to the first position (see FIG. 10) and the second position (see FIG. 11) by an action spring 32. The action spring 32 includes a winding part 32aand a pair of arms 32b and 32c protruding from the winding part 32a. The winding part 32ais pivotally supported by the fence block 15. The first arm 32bis locked to the fence block 15 (see FIG. 7). The second arm 32cincludes a mountain-shaped biasing projection 32d, and biases a protrusion 31c protruding rearward in the vehicle length direction from the base plate 31a. The lock plate 31 is biased to the first position illustrated in FIG. 10 when the protrusion 31c is biased on the base end side (the winding part 32a side) of the second arm 32c with respect to the top portion of the biasing projection 32d. The lock plate 31 is biased to the second position illustrated in FIG. 11 when the protrusion 31c is biased on the edge side of the second arm 32c with respect to the top portion of the biasing projection 32d.

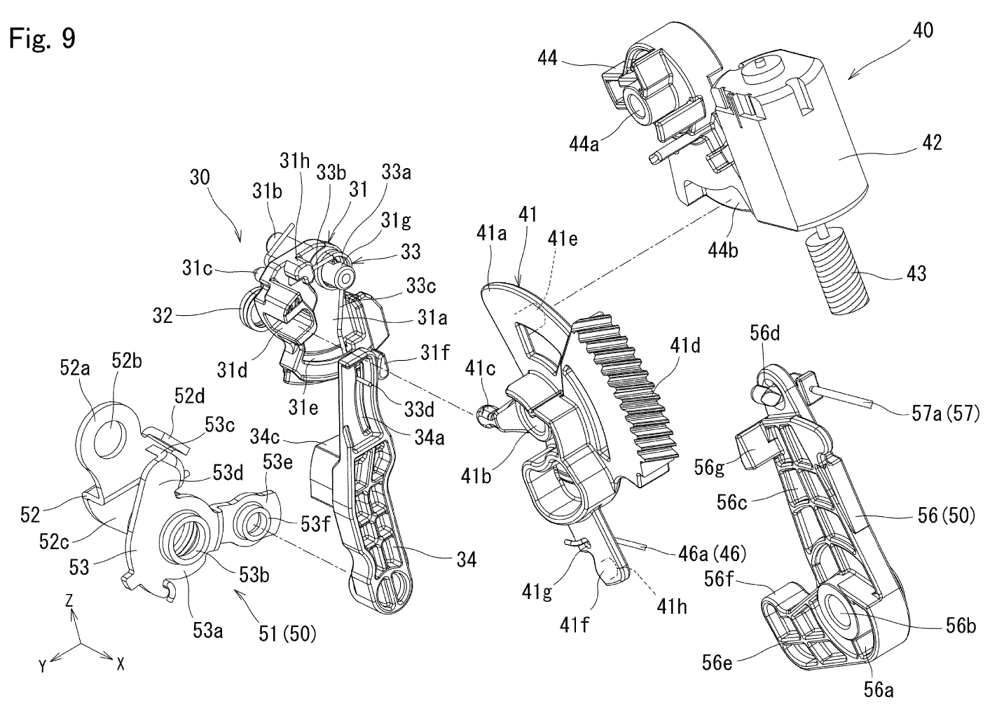

See FIGS. 7 and 9. The coupling receiving part 31d is configured to receive an operation of a switching operation part 41c of the rotor 41 and pivot the lock plate 31 to the first position (see FIG. 10) and the second position (see FIG. 11). The coupling receiving part 31d has a U-shaped section and protrudes forward in the vehicle length direction from the upper portion of the base plate 31a.

See FIGS. 8 and 9. The insertion groove 31e is configured to movably insert the coupling spring 33. The insertion groove 31e is provided in a lower step portion of the base plate 31a, and penetrates the lower step portion of the base plate 31a in the thickness direction and extends in the vehicle width direction.

The positioning part 31f is configured to position the link 34 in the vehicle width direction in cooperation with the coupling spring 33. The positioning part 31f is provided at an end of the insertion groove 31e on the inner side in the vehicle width direction which is the biasing direction with the coupling spring 33, and protrudes forward in the vehicle length direction. The positioning part 31f also has a function of abutting on a side portion on the inner side in the vehicle width direction of the link 34 biased by the coupling spring 33 and supporting the link 34 so as to be movable in the up-down directions.

See FIGS. 8 and 9. The coupling spring 33 is configured to movably couple the upper portion of the link 34. The coupling spring 33 is mainly attached to the front surface of the base plate 31a in the vehicle length direction. The coupling spring 33 includes a winding part 33a and a pair of arms 33b and 33c protruding from the winding part 33a. The winding part 33a is attached to a shaft part 31g protruding forward in the vehicle length direction from an upper portion of the base plate 31a. The first arm 33b is locked to a locking part 31h provided on the base plate 31a.

The second arm 33c protrudes downward from the lock plate 31. More specifically, the second arm 33c passes through the insertion groove 31e and then protrudes downward from the base plate 31a. A coupling part (first coupling part) 33d that movably couples an upper portion of the link 34 is provided at a lower end of the second arm 33c. The coupling part 33d protrudes forward in the vehicle length direction, and also has a function of guiding the link 34 when the link 34 moves in the up-down directions. The coupling part 33d is not limited to the configuration provided in the coupling spring 33 separate from the lock plate 31, but can be changed as necessary as long as the link 34 can be coupled to the lock plate 31.

See FIGS. 6 and 7. The link 34 is configured to make the opening operation receiving part 24b of the claw 24 operable when moved to the unlock position (see FIG. 10), and to make the opening operation receiving part 24b of the claw 24 inoperable when moved to the lock position (see FIG. 11). The link 34 has an elongated plate shape extending in the up-down directions. The upper end side of the link 34 is movably coupled to the coupling spring 33, and the lower end side of the link 34 is pivotally coupled to the outer lever 51. This allows the upper side of the link 34 to be pivotable around the shaft part 34b as the coupling part with the outer lever 51. The link 34 is movable in the up-down directions with the outer lever 51 or the inner lever 56.

See FIGS. 8 and 9. A guide groove 34a coupled to and held by the coupling part 33d of the coupling spring 33 is provided on an upper portion of the link 34. The guide groove 34a extends in the up-down directions with a groove width allowing insertion of the coupling part 33d, and allows relative movement of the link 34 with respect to the coupling part 33d. A shaft part 34b coupled to and held by the outer lever 51 is provided at the lower end of the link 34. The shaft part 34b has a columnar shape and protrudes rearward in the vehicle length direction.

See FIGS. 6 and 13. An unlatching operation part 34c for operating the opening operation receiving part 24b of the claw 24 is provided between the guide groove 34a and the shaft part 34b of the link 34. The unlatching operation part 34c protrudes rearward in the vehicle length direction toward the claw 24.

See FIGS. 10 and 13. The unlatching operation part 34c is located immediately below the opening operation receiving part 24b when the link 34 is moved to the unlock position. Thus, when the link 34 is moved upward, the unlatching operation part 34c moves the opening operation receiving part 24b upward (see FIG. 14). As a result, as illustrated in FIG. 2, the claw 24 can be pivoted to the locking release position, and the lock mechanism 30 can be switched to the unlatched state.

See FIG. 11. When the link 34 is moved to the lock position, the unlatching operation part 34c is positioned in the vehicle width direction with a space from the opening operation receiving part 24b. Thus, even though the link 34 is moved upward, the unlatching operation part 34c cannot abut on the opening operation receiving part 24b but is idled (see FIG. 12). As a result, as illustrated in FIG. 4, the claw 24 is maintained at the locking position, and the lock mechanism 30 cannot be switched to the unlatched state (see FIG. 2).

Here, the door latch device 10 of the present embodiment is of an electric type in which the ECU 5 (see FIG. 1) operates the motor 42 to switch the lock mechanism 30 between the unlocked state (see FIG. 10) and the locked state (see FIG. 11) through a predetermined operation by a user carrying a specific electronic key (not illustrated) in normal times. A mechanical key (not illustrated) for operating the key cylinder 6 (see FIG. 1) is incorporated in the electronic key and is not normally used.

On the other hand, in an emergency in which the lock mechanism 30 cannot be switched by the motor 42, such as when the charge capacity of a battery (not illustrated) mounted on the vehicle is small, the key cylinder 6 (see FIG. 1) is operated using the mechanical key taken out from the electronic key. This can switch the lock mechanism 30 between the unlocked state (see FIG. 10) and the locked state (see FIG. 11). However, the operation of taking out the mechanical key from the electronic key is complicated because it is necessary to use a tool or the like. Thus, it is not suitable for handling when there is a circumstance of leaving the vehicle, and the door 1 (see FIG. 2) needs to be immediately locked. For example, in the door latch device 10 of the rear door 1 of the vehicle, the key cylinder 6 (see FIG. 1) and the lock knob 4 (see FIG. 1) are not mounted in some cases. In such a case, the lock mechanism 30 cannot be switched between the unlocked state (see FIG. 10) and the locked state (see FIG. 11) when the charge capacity of the battery (not illustrated) is small, for example.

Thus, as illustrated in FIGS. 2, 4, and 6, the door latch device 10 of the present embodiment is provided with a lock operation part 31i for directly performing locking operation on the lock mechanism 30.

The lock operation part 31i is provided on the base plate 31a of the lock plate 31 so as to correspond to the insertion groove 15a of the fence block 15. The lock operation part 31i is provided at an interval with respect to the pivot shaft 31b and protrudes rearward (door outer side) in the vehicle length direction. As viewed from the rear side in the vehicle length direction, the lock operation part 31i has an arc shape, and protrudes (curves) outward in the vehicle width direction corresponding to the lock operation direction.

The fence block 15 is provided with an opening 15d that exposes the lock operation part 31i to the outer side of the door 1. The opening 15d is provided at the bottom of the insertion groove 15a so as to be located in the insertion groove 15a. The opening 15d extends along the insertion groove 15a. More specifically, the opening 15d has an arc shape extending in a circumferential direction around the bearing part 15c (see FIG. 7) corresponding to the pivot shaft 31b and allows the movement (operation) of the lock operation part 31i along the extending direction.

The base plate 31a of the lock plate 31 is formed in a fan shape of having an angular range capable of closing the opening 15d from an orientation pivoted to the first position (see FIG. 10) to an orientation pivoted to the second position (see FIG. 11). The gap between the base plate 31a and the opening 15d is set to a dimension capable of preventing intrusion of foreign matter such as dust.

In the lock mechanism 30 configured like this, in the unlocked state illustrated in FIG. 10, the lock operation part 31i can be operated outward in the vehicle width direction from the rear end side (door outer side) in the vehicle length direction of the door 1 (see FIG. 2). This can transmit the operating force of the lock operation part 31i directly to the lock plate 31, and the lock plate 31 can be pivoted from the first position illustrated in FIG. 10 to the second position illustrated in FIG. 11. As a result, the link 34 can be pivoted together, and the lock mechanism 30 can be switched to the locked state illustrated in FIG. 11. Thus, the user can manually lock the door 1 (see FIG. 2) when there is a circumstance of leaving the vehicle. Thus, user convenience can be improved.

### Configuration of switching mechanism

See FIGS. 3 and 7. The rotor 41, the motor 42, and the key lever 44 constituting the switching mechanism 40 are attached to the second portion 13b of the housing body 13.

The rotor 41 is pivotally supported by a rotor shaft 13c provided in the housing body 13. See FIGS. 8, 9, and 13. The rotor 41 includes a fan-shaped base plate 41a extending in the vehicle length direction and the vehicle height direction and having an angular range of a semicircle or wider range (approximately 135 degrees). The base plate 41a is provided with a shaft hole part 41b pivotally supported by a rotor shaft 13c (see FIG. 3). A switching operation part (second coupling part) 41c that is coupled to the coupling receiving part 31d of the lock plate 31 and switches the lock mechanism 30 between the locked state and the unlocked state is provided at a position facing the lock plate 31 on the outer periphery of the base plate 41a. The switching operation part 41c protrudes rearward in the vehicle length direction from the base plate 41a, and includes a substantially spherical coupling part at the edge.

The rotor 41 further includes a gear part 41d for connection to the motor 42, a connection projection 41e for connection to the key lever 44, and an operation receiving part 41f for receiving an operation from another member. The gear part 41d is configured by a part of a worm wheel, and is provided on a part of the front side in the vehicle length direction of the base plate 41a. The connection projection 41e has a columnar shape and protrudes inward in the vehicle width direction from the upper portion of the base plate 31a. The operation receiving part 41f has a plate shape extending in the vehicle length direction and the vehicle height direction, and protrudes downward from the outer periphery of the base plate 41a.

The operation receiving part 41f is provided with a cable coupling part 41g formed of a hole penetrating therethrough and coupling the knob cable 46. One end of the wire 46a of the knob cable 46 having the end coupled to the lock knob 4 (see FIG. 1) is coupled to the cable coupling part 41g. Here, the knob cable 46 is configured by a push-pull cable including a wire 46a capable of pushing and pulling the operation receiving part 41f.

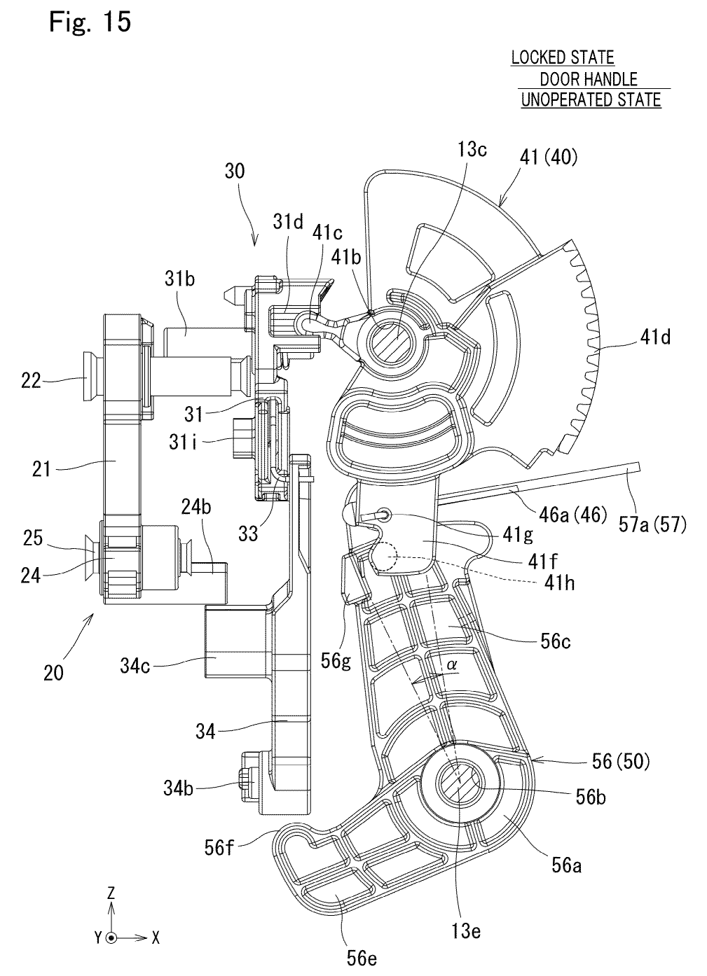

The rotor 41 is pivoted clockwise from the unlock operation position illustrated in FIG. 13 by the lock operation of the lock knob 4 (see FIG. 1), and the lock plate 31 is pivoted clockwise in FIG. 10 by the switching operation part 41c. This can switch the lock mechanism 30 to the locked state illustrated in FIG. 11. On the other hand, the rotor 41 is pivoted counterclockwise from the lock operation position illustrated in FIG. 15 by the unlock operation of the lock knob 4 (see FIG. 1), and the lock plate 31 is pivoted counterclockwise in FIG. 11 by the switching operation part 41c. This can switch the lock mechanism 30 to the unlocked state illustrated in FIG. 10.

The motor 42 is attached adjacent to the front side of the rotor 41 in the vehicle length direction. A worm 43 meshing with the gear part 41d of the rotor 41 is attached to the output shaft of the motor 42. The motor 42 pivots the rotor 41 clockwise from the unlock operation position illustrated in FIG. 13 through normal rotation. On the other hand, the motor 42 pivots the rotor 41 counterclockwise from the lock operation position illustrated in FIG. 15 through reverse rotation. This can switch the lock mechanism 30 between the locked state illustrated in FIG. 11 and the unlocked state illustrated in FIG. 10 similarly to the switching operation with the lock knob 4 (see FIG. 1).

See FIGS. 3 and 7. The key lever 44 is disposed adjacent to the inner side of the rotor 41 in the vehicle width direction, and is pivotally supported by a pivot shaft 13d provided in the housing body 13. The key lever 44 is coupled to a rod coupling member 45 pivotally disposed on the housing body 13. See FIGS. 8 and 9. The key lever 44 includes a shaft hole part 44a pivotally supported by the pivot shaft 13d (see FIG. 3) and a connection recess 44b connected to the connection projection 41e of the rotor 41. The connection recess 44b is recessed inward from the surface of the key lever 44 located on the outer side in the vehicle width direction and has a fan shape extending in the circumferential direction around the shaft hole part 44a. When the key lever 44 is pivoted clockwise in FIG. 9 through the key operation, the rotor 41 is pivoted counterclockwise from the lock operation position illustrated in FIG. 15 to the unlock operation position illustrated in FIG. 13. On the other hand, when the key lever 44 is pivoted counterclockwise in FIG. 9 through the key operation, the rotor 41 is pivoted clockwise from the unlock operation position illustrated in FIG. 13 to the lock operation position illustrated in FIG. 15. This can switch the lock mechanism 30 between the locked state illustrated in FIG. 11 and the unlocked state illustrated in FIG. 10 similarly to the switching operation with the lock knob 4 (see FIG. 1).

### Configuration of outer lever of opening mechanism

See FIGS. 4, 5, and 7. The outer lever 51 constituting the opening mechanism 50 is pivotally attached to the front side (door inner side) in the vehicle length direction of the fence block 15. The outer lever 51 includes a first lever 52 and a second lever 53.

See FIGS. 6 and 7. The fence block 15 is provided with a penetration part 15e penetrating in the vehicle length direction at a position corresponding to the disposition portion of the first lever 52 below the insertion groove 15a. The penetration part 15e extends in the vehicle width direction along the insertion groove 15a.

In a portion of the fence block 15 located above the penetration part 15e, a pivot shaft (first pivot shaft) 15f that pivotally supports the first lever 52 is integrally provided. In a portion of the fence block 15 located below the penetration part 15e, a pivot shaft (second pivot shaft) 15g that pivotally supports the second lever 53 is integrally provided. That is, the pivot shafts 15f and 15g are provided at intervals on both upper and lower sides with the penetration part 15e interposed therebetween. These pivot shafts 15f and 15g protrude forward in the vehicle length direction, which is a direction orthogonal to the extending direction (YZ plane) of the fence block 15, and extend in parallel.

See FIGS. 4 and 6. A accommodation part 15h that pivotally accommodates a first input part 52c of the first lever 52 described later in detail is provided on the rear side (door outer side) in the vehicle length direction of the fence block 15. The accommodation part 15h is provided below the penetration part 15e, is recessed forward from the rear side in the vehicle length direction, and extends in the vehicle width direction along the penetration part 15e. The inside of the accommodation part 15h and the inside of the penetration part 15e are spatially communicated. An opening on the rear side (door outer side) in the vehicle length direction of the accommodation part 15h is closed by a cover 18 (see FIG. 2).

A cable fixing part 15i is provided on an outer wall of the fence block 15 in the vehicle width direction that defines the accommodation part 15h. The cable fixing part 15i is formed of a cutout that opens the rear side in the vehicle length direction, and fixes an end of a tube 55b through which a wire 55a of the outer door cable 55 is inserted so that the wire can move back and forth.

See FIGS. 7 to 9. The first lever 52 includes a base 52a in which a shaft hole part 52b pivotally supported by the pivot shaft 15f is formed. The first lever 52 includes the first input part 52c to which the outer door cable 55 is coupled and a first output unit 52d that operates the second lever 53, and receives an operating force of the outer door handle 7 (see FIG. 1) and transmits the operating force to the second lever 53.

The first input part 52c penetrates the penetration part 15e and is disposed in the accommodation part 15h (door outer side) located on the rear side in the vehicle length direction in the fence block 15 (see FIG. 4). The first input part 52c is bent rearward in the vehicle length direction from a portion located on the lower side of the outer periphery of the base 52a, and then bent downward. As viewed from the rear side in the vehicle length direction, the first input part 52c has an arc shape curved inward in the vehicle width direction, which is a direction away from the cable fixing part 15i (see FIG. 4). The edge of the first input part 52c protrudes to the side opposite to the pivot shaft 15f of the first lever 52 with respect to the pivot shaft 15g of the second lever 53. The edge of the first input part 52c protrudes downward with respect to the pivot shaft 15g of the second lever 53 (see FIG. 10). One end of the wire 55a (see FIG. 4) of the outer door cable 55 having the other end coupled to the outer door handle 7 (see FIG. 1) is coupled to the edge of the first input part 52c.

See FIG. 10. The first input part 52c is pulled outward in the vehicle width direction (left side in FIG. 10) via the outer door cable 55 through the operation of the outer door handle 7 (see FIG. 1). This causes the entire first lever 52 to pivot around the pivot shaft 15f in a clockwise direction A (first direction) in FIG. 10. In the unoperated state of the outer door handle 7 (see FIG. 1), the first input part 52c is located on the axis line of the pivot shaft 15g of the second lever 53. Thus, the trajectory of pivot movement of the first input part 52c formed by the pivot of the first lever 52 intersects the axis line of the pivot shaft 15g of the second lever 53. In other words, the pivot shaft 15g that pivotally supports the second lever 53 is provided so as to be located on the front side in the vehicle length direction of the first input part 52c.

The first output part 52d is disposed on the front side (door inner side) in the vehicle length direction of the fence block 15 on the same side as the base 52a. The first output part 52d has a flat plate shape, and is provided to be bent forward in the vehicle length direction from a portion located on the inner side in the vehicle width direction and above the center in the vehicle height direction in the outer periphery of the base 52a. See FIG. 10. The first output part 52d moves downward in the clockwise direction through the pivot of the first lever 52 in the direction A.

See FIGS. 5 to 7. The second lever 53 includes a base 53a in which a shaft hole part 53b pivotally supported by the pivot shaft 15g is formed. The second lever 53 includes a second input part 53c that receives the operation of the first lever 52 and a second output part 53e coupled to the link 34, and receives the operating force of the outer door handle 7 (see FIG. 1) from the first lever 52 and transmits the operating force to the link 34. The entire second lever 53 including the second input part 53c and the second output part 53e is disposed on the front side (door inner side) in the vehicle length direction of the fence block 15.

See FIGS. 8 to 10. The second input part 53c is provided immediately below the first output part 52d of the first lever 52, that is, on the trajectory of pivot movement in the direction A in which the first output part 52d is pivoted by the operation of the outer door handle 7 (see FIG. 1). The second input part 53c is provided at an edge of the arm 53d protruding radially outward from the base 53a, and protrudes rearward (door outer side) in the vehicle width direction. As illustrated most clearly in FIG. 10, the second input part 53c has an arc shape, and the flat first output part 52d can be brought into sliding contact with the second input part in a line contact state.

When the first lever 52 pivots in the direction A, the second input part 53c is pressed leftward in FIG. 10 by the first output part 52d. This causes the second lever 53 to pivot about the pivot shaft 15g from the initial position illustrated in FIG. 10 to the operation position (see FIG. 12) in a counterclockwise direction B (second direction). That is, the second lever 53 pivots in the direction B different from the direction A in which the first lever 52 pivots. As illustrated most clearly in FIG. 8, a spring 54 that biases the second lever 53 to the initial position illustrated in FIG. 10 is attached to the pivot shaft 15g. One end of the spring 54 is locked to the second lever 53, and the other end of the spring 54 is locked to the fence block 15.

As illustrated most clearly in FIG. 10, the second input part 53c and the first output part 52d are disposed between the pivot shaft 15g of the second lever 53 and the pivot shaft 15f of the first lever 52, respectively. The second input part 53c and the first output part 52d are disposed on the inner side in the vehicle width direction with respect to a reference line L connecting the axis line of the pivot shaft 15g of the second lever 53 and the axis line of the pivot shaft 15f of the first lever 52, that is, on the side opposite to the direction (outer side in the vehicle width direction) in which the first lever 52 is pulled by the outer door cable 55 (see FIG. 4). This allows the pivot power of the first lever 52 to be reliably transmitted to the second lever 53.

The second output part 53e protrudes inward in the vehicle width direction from the outer periphery of the base 53a toward the link 34. A support 53f that pivotally supports the shaft part 34b of the link 34 is provided on the edge side of the second output part 53e. The support part 53f has a cylindrical shape and is provided so as to protrude forward in the vehicle length direction through burring. When the second lever 53 pivots in the direction B, the second output part 53e moves counterclockwise upward in FIG. 10. This allows the second output part 53e to move the link 34 upward, to pivot the claw 24 to the locking release position, and to switch the latch mechanism 20 to the unlatched state (see FIG. 2).

In this manner, the first input part 52c of the first lever 52 is disposed on the rear side (door outer side) in the vehicle length direction of the fence block 15, and the second lever 53 including the second input part 53c and the second output part 53e is disposed on the front side (door inner side) in the vehicle length direction of the fence block 15. Thus, the first input part 52c of the first lever 52 does not interfere with the second lever 53 when it pivots. This allows the first lever 52 and the second lever 53 to be disposed close to each other in the vehicle width direction. Thus, it is possible to reduce the projection area necessary for the disposition of the outer lever 51 including the pair of levers 52 and 53.

### Configuration of inner lever of opening mechanism

See FIGS. 3, 5, and 7. The inner lever 56 constituting the opening mechanism 50 is pivotally supported by a lever shaft 13e provided in the housing body 13.

The lever shaft 13e is provided with a space below the rotor shaft 13c from the housing body 13. The lever shaft 13e protrudes inward in the vehicle width direction from the housing body 13 and extends in parallel along the rotor shaft 13c pivotally supporting the rotor 41. However, the lever shaft 13e does not have to extend in parallel with the rotor shaft 13c in a geometrically strict sense as long as the inner lever 56 can be pivoted in contact with the rotor 41 as will be described in detail later.

See FIGS. 8, 9, and 13. The inner lever 56 includes a base 56a in which a shaft hole part 56b pivotally supported by the lever shaft 13e is formed. The inner lever 56 includes a cable coupling part (first cable coupling part) 56c protruding from the base 56a and an opening operation part 56e, and has an L shape as viewed from the direction in which the lever shaft 13e extends.

The cable coupling part 56c protrudes upward from the base 56a. A coupling hole 56d for coupling the inner door cable (first cable) 57 is provided at the upper end of the cable coupling part 56c. One end of the wire 57a of the inner door cable 57 having the other end connected to the inner door handle 8 (see FIG. 1) is coupled to the coupling hole 56d. The upper end of the cable coupling part 56c is located between the lever shaft 13e and the rotor shaft 13c of the rotor 41 in the vehicle height direction. When the inner door handle 8 (see FIG. 1) is operated, the cable coupling part 56c is pulled rightward in FIG. 13. This causes the inner lever 56 to pivot clockwise in FIG. 13 around the lever shaft 13e.

The opening operation part 56e protrudes rearward in the vehicle length direction from the base part 56a and extends to the lower side of the link 34. A pressing part 56f that presses the lower end of the link 34 to move upward is provided at the edge of the opening operation part 56e. The pressing part 56f has a semicircular section and protrudes upward toward the link 34. When the inner lever 56 is pivoted through the operation of the inner door handle 8 (see FIG. 1), the opening operation part 56e moves the link 34 upward by moving upward. In other words, the opening operation part 56e transmits the operating force of the inner door handle 8 (see FIG. 1) to the latch mechanism 20 via the link 34 of the lock mechanism 30 in the unlocked state, and switches the latch mechanism 20 to the unlatched state (see FIG. 2).

Here, the operation receiving part 41f included in the rotor 41 of the switching mechanism 40 described above protrudes downward from the outer periphery of the base plate 41a and is located between the lever shaft 13e and the rotor shaft 13c. The operation receiving part 41f is positioned with a space from the cable coupling part 56c of the inner lever 56 in the axial direction of the lever shaft 13e and the rotor shaft 13c. Moreover, the operation receiving part 41f is provided at a position where the trajectory of pivot movement overlaps the cable coupling part 56c as viewed from the axial direction of the lever shaft 13e and the rotor shaft 13c.

In this manner, the cable coupling part 56c of the inner lever 56 and the operation receiving part 41f of the rotor 41 are disposed between the lever shaft 13e and the rotor shaft 13c, respectively. Thus, it is not necessary to individually secure the pivot spaces of the cable coupling part 56c of the inner lever 56 and the operation receiving part 41f of the rotor 41. In addition, as illustrated in FIG. 3, because the two cables 46 and 57 are disposed close to each other, these positioning structures can be assembled together at the same position without being individually provided in the housing 12.

A cable coupling part 41g is formed in the operation receiving part 41f of the rotor 41 of the present embodiment. Thus, by coupling the knob cable (second cable) 46 to the cable coupling part 41g, it is possible to configure the door latch device 10 of a lock knob specification in which the lock mechanism 30 is switched between the locked state and the unlocked state through the operation of the lock knob 4 (see FIG. 1).

On the other hand, an automobile manufacturer may request that the door latch device 10 have an override function of switching the lock mechanism 30 to the unlocked state through operation of the inner door handle 8 (see FIG. 1). Thus, in the present embodiment, it is possible to easily cope with the situation in which the presence or absence of the override function needs to be chosen depending on the request of the automobile manufacturer without changing the basic configuration.

Specifically, in the present embodiment, as illustrated in FIGS. 8 and 13, the abutment receiving part 41h is further provided in the operation receiving part 41f of the rotor 41, and the abutting part 56g is further provided in the inner lever 56. This can realize both a lock knob specification in which the state of the lock mechanism 30 can be switched by the lock knob 4 (see FIG. 1) and an override specification in which the lock mechanism 30 can be switched to the unlocked state by the inner door handle 8 (see FIG. 1).

See FIGS. 8 and 13. The abutting part 56g of the inner lever 56 is provided on a side portion of the rear side in the vehicle length direction in the upper portion of the cable coupling part 56c. The abutting part 56g has a plate shape and protrudes outward in the vehicle width direction. As the inner lever 56 pivots to move the claw 24 to the locking release position (see FIGS. 2 and 14), the abutting part 56g pivots in an angular range α.

The abutment receiving part 41h of the rotor 41 is provided at the lower end of the operation receiving part 41f. The abutment receiving part 41h has a columnar shape and protrudes inward in the vehicle width direction from the plate-like base plate 41a. When the rotor 41 is pivoted to the unlock operation position illustrated in FIGS. 13 and 14, the abutment receiving part 41h is positioned on the front side in the vehicle length direction with a space from the angular range α of the abutting part 56g. Thus, even though the inner lever 56 pivots in this state, the abutting part 56g cannot abut on the abutment receiving part 41h, and the rotor 41 cannot be operated.

On the other hand, when the rotor 41 pivots to the lock operation position illustrated in FIG. 15, the abutment receiving part 41h moves to the rear side in the vehicle length direction and is located within the angular range α of the abutting part 56g. Thus, when the inner lever 56 pivots in this state, the abutting part 56g abuts on the abutment receiving part 41h, and pivots the rotor 41 to the unlock operation position illustrated in FIG. 14. This can switch the lock plate 31 to the unlocked state (see FIG. 10). At this time, because the link 34 has moved to the upper position illustrated in FIG. 12, the unlatching operation part 34c interferes with the side of the opening operation receiving part 24b, and the link cannot be switched to the unlocked state. When the inner lever 56 returns to the initial position illustrated in FIG. 13, the link 34 moves downward from the upper position illustrated in FIG. 12 toward the initial position illustrated in FIG. 10 with the biasing force of the spring 54. Then, the interference between the opening operation receiving part 24b and the unlatching operation part 34c is eliminated, and the link 34 moves from the lock position to the unlock position with the biasing force of the coupling spring 33. Thus, to switch the latch mechanism 20 to the unlatched state, it is necessary to operate the inner door handle 8 (see FIG. 1) again (twice) (two motions). However, by adjusting the positions of the abutment receiving part 41h and the abutting part 56g, both the unlocking of the lock mechanism 30 and the unlatching of the latch mechanism 20 can be performed by one operation of the inner door handle 8 (see FIG. 1) (one motion).

In the door latch device 10 configured as described above, the rotor 41 is pivoted by the lock knob 4 (see FIG. 1), and the state of lock mechanism 30 can be switched (lock knob specification). As illustrated in FIGS. 11 and 15, when the lock mechanism 30 is in the locked state, the lock mechanism 30 can be switched to the unlocked state illustrated in FIGS. 10 and 13 by operating the inner door handle 8 (see FIG. 1) and pivoting the inner lever 56 (override specification).

On the other hand, when the knob cable 46 is not coupled to the rotor 41 without using the lock knob 4 (see FIG. 1) for the door 1 (see FIG. 2), the door latch device 10 can be set to an override specification in which the lock mechanism 30 cannot be switched by the lock knob 4 (see FIG. 1), but the lock mechanism 30 can be unlocked by the inner door handle 8 (see FIG. 1).

When the abutting part 56g is not provided in the inner lever 56, the door latch device 10 can be set to a lock knob specification in which the lock mechanism 30 cannot be unlocked by the inner door handle 8 (see FIG. 1), but the lock mechanism 30 can be switched by the lock knob 4 (see FIG. 1). That is, when the first inner lever 56 including the abutting part 56g and the second inner lever 56 not including the abutting part 56g are prepared, and the first or second inner lever 56 is used according to the specifications of the automobile manufacturer, it is possible to cope with the situation in which the presence or absence of the override function needs to be chosen.

The door latch device 10 according to the present embodiment has the following features.

The lever shaft 13e of the inner lever 56 is disposed below the rotor shaft 13c of the rotor 41, and the cable coupling part 56c of the inner lever 56 is disposed between the lever shaft 13e and the rotor shaft 13c. The rotor 41 is provided with an operation receiving part 41f so as to be positioned between the lever shaft 13e and the rotor shaft 13c. That is, the cable coupling part 56c of the inner lever 56 and the operation receiving part 41f of the rotor 41 are disposed between the lever shaft 13e and the rotor shaft 13c, respectively. Thus, it is not necessary to individually secure the pivot spaces of the cable coupling part 56c of the inner lever 56 and the operation receiving part 41f of the rotor 41. Thus, the door latch device 10 can be downsized as compared with the case where the pivot spaces of the cable coupling part 56c of the inner lever 56 and the operation receiving part 41f of the rotor 41 are individually secured.

The operation receiving part 41f of the rotor 41 receives an operation from at least wither the lock knob 4 or the inner lever 56 provided on the door 1. Specifically, by coupling the knob cable 46 coupled to the lock knob 4 to the operation receiving part 41f of the rotor 41, it is possible to configure the door latch device 10 of a lock knob specification in which the lock mechanism 30 is switched between the locked state and the unlocked state through the operation of the lock knob 4. On the other hand, when the operation receiving part 41f of the rotor 41 receives the operation by the inner lever 56, the door latch device 10 of the override specification in which the lock mechanism 30 is switched to the unlocked state by the operation of the inner door handle 8 can be configured. In this manner, the door latch device 10 of the lock knob specification and the override specification can be realized by a common component layout. Thus, it is possible to easily cope with the situation to choose the presence or absence of the override function determined by the request of the automobile manufacturer without changing the basic configuration.

Specifically, the operation receiving part 41f of the rotor 41 is provided with the cable coupling part 41g to which the knob cable 46 coupled to the lock knob 4 is coupled, and the abutment receiving part 41h that abuts on the abutting part 56g of the pivoted inner lever 56 and pivots the rotor 41 so as to switch the lock mechanism 30 to the unlocked state. With this configuration, by using the inner lever 56 not provided with the abutting part 56g, the door latch device 10 having a lock knob specification not provided with an override function can be configured. On the other hand, by using the inner lever 56 including the abutting part 56g, the door latch device 10 of the override specification can be configured. Since rotor 41 can be used as a common component in any specification, the manufacturing cost of the door latch device 10 can be reduced.

The cable coupling part 56c of the inner lever 56 and the operation receiving part 41f of the rotor 41 are disposed at intervals in the axial direction of the lever shaft 13e and the rotor shaft 13c, and they are provided at positions overlapping each other as viewed from the axial direction. This enables the inner door cable 57 and the knob cable 46 to be disposed close to each other, and thus, it is not necessary to individually provide these positioning structures in the housing. Thus, the door latch device 10 can be downsized as compared with a case where the positioning structures of the two cables 46 and 57 are individually provided. In addition, because the two cables 46 and 57 are assembled together at the same position, workability at the time of assembly can be improved.

The present invention is not limited to the configuration of the above-described embodiment, and various modifications can be made.

For example, the operation receiving part 41f of the rotor 41 does not have to be provided with the cable coupling part 41g of the knob cable 46, and does not have to be provided with the abutment receiving part 41h on which the inner lever 56 abuts. The cable coupling part 56c may be configured to abut on the abutment receiving part 41h of the rotor 41 without providing the abutting part 56g on the inner lever 56.

The operation receiving part 41f of the rotor 41 and the cable coupling part 56c of the inner lever 56 may be provided at positions where the trajectories of pivot movement do not overlap as viewed from the direction in which the rotor shaft 13c and the lever shaft 13e extend.

The cable coupling part 56c of the inner lever 56 and the operation receiving part 41f of the rotor 41 may be provided such that at least a part of the trajectories of pivot movement overlap as viewed from the direction in which the rotor shaft 13c and the lever shaft 13e extend.

What is claimed is:

1. A door latch device comprising:
a latch mechanism that is mounted in a door and releasably holds a striker provided in a vehicle body;
a lock mechanism that is switchable between an unlocked state in which an operating force of an inner door handle provided in the door can be transmitted to the latch mechanism and a locked state in which the operating force cannot be transmitted;
an inner lever including a first cable coupling part to which one end of a first cable having the other end connected to the inner door handle is coupled, and an opening operation part that transmits the operating force of the inner door handle to the latch mechanism via the lock mechanism in the unlocked state, the inner lever being pivotally supported by a lever shaft; and
a rotor including a switching operation part that switches the lock mechanism between the locked state and the unlocked state, the rotor being pivotally supported by a rotor shaft extending along the lever shaft to allow pivot with a motor, wherein
the lever shaft of the inner lever is disposed below the rotor shaft of the rotor,
the first cable coupling part of the inner lever is disposed between the lever shaft and the rotor shaft, and
the rotor is provided with an operation receiving part that receives an operation from at least either a lock knob provided on the door or the inner lever to be positioned between the lever shaft and the rotor shaft.

2. The door latch device according to claim 1, wherein the operation receiving part is provided with a second cable coupling part to which the one end of a second cable having the other end coupled to the lock knob is connected.

3. The door latch device according to claim 2, wherein the first cable coupling part of the inner lever and the second cable coupling part of the rotor are disposed at an interval in an axial direction of the lever shaft and the rotor shaft, and the first cable coupling part and the second cable coupling part are provided at positions overlapping each other as viewed from the axial direction.

4. The door latch device according to claim 1, wherein
the inner lever is provided with an abutting part, and
the operation receiving part of the rotor is provided with an abutment receiving part that abuts on the abutting part through pivot of the inner lever through operation of the inner door handle and pivots the rotor to switch the lock mechanism to the unlocked state.

5. The door latch device according to claim 4, wherein the first cable coupling part of the inner lever and the operation receiving part of the rotor are disposed at an interval in an axial direction of the lever shaft and the rotor shaft, and the first cable coupling part and the operation receiving part are provided at positions overlapping each other as viewed from the axial direction.

6. The door latch device according to claim 1,
wherein the operation receiving part of the rotor is provided with:
a second cable coupling part to which one end of a second cable having the other end coupled to the lock knob is connected; and
an abutment receiving part on which the inner lever pivoted through an operation of the inner door handle abuts, the abutment receiving part being configured to pivot the rotor to switch the lock mechanism to the unlocked state.
